(19) United States
(12) Patent Application Publication
(10) Pub. No.: US 2006/0237152 A1
(43) Pub. Date: Oct. 26, 2006

(54) Window shade with pinch protection

(75) Inventors: Melf Hansen, Gondelsheim (DE); Werner P. Schlecht, Aurich (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: BOS GmbH Co. KG, Ostfildern (DE)

(21) Appl. No.: 11/407,581

(22) Filed: Apr. 20, 2006

(30) Foreign Application Priority Data
Apr. 21, 2005 (DE) 10 2005 018 903.2
Jun. 23, 2005 (DE) 10 2005 029 560.6

(51) Int. Cl. B60J 1/20

(52) U.S. Cl. 160/370.22

(57) ABSTRACT

A window roller blind assembly for motor vehicles which includes a roller blind that can be drawn from a wind-up shaft by a motor driven driving element engageable with a pull rod of the roller blind. The pull rod, which is guided for movement in guide rails, has a braking device that causes at least part of the driving force necessary for moving the window shade to be fed into the guide rail to brake further movement of the roller blind when the pull rod bumps into an obstacle.

### FIELD OF THE INVENTION

This present invention relates generally to window shades, and more particularly, to power operated window shades for motor vehicles.

### BACKGROUND OF THE INVENTION

Electronically operated sun shades are increasingly being used in motor vehicles. These sun shades are used on the side windows of the rear doors, the rear window, or the glass roof. A window shade for rear windows is known, for example, from DE 103 51 040 A1. The rear window shade described therein comprises a winding shaft rotatably mounted underneath a rear shelf to which one edge of a roller blind shade is fastened. The free end of the roller blind is connected to a pull rod or tension member. The pull rod is tubular and accommodates two guide pieces, which are provided on each end of the pull rod. The guide pieces run in guide rails, which are arranged laterally beside the rear window in inner side paneling of the motor vehicle. The pull rod is driven via linear thrust elements that run in the guide rails. On the other hand, the driving elements are positive-locking via a toothed wheel of a gear motor. The shades for motor vehicle side windows or the shades of skylights basically have the same design.

Because of the electro-motor driving mechanism, there is a certain risk of a passenger being pinched during operation of the window shade since the drive motor typically is overdesigned with respect to the driving power available. Turning off the motor is time-controlled as a rule, which means that when the shade is extended, the tension rod bears against a positive locking stop and remains pressed there with considerable force until the motor is turned off by a time function element.

Since the operating force is relatively high, there is a risk of injury if someone were to reach between the moving pull rod and a fixed stop in the vehicle. The danger is particularly high for side windows, when the side window is lowered.

### OBJECTS AND SUMMARY OF THE INVENTION

It is an object of the invention to provide a window shade for motor vehicles that is operable for preventing personal injury to persons being caught by the window shade during its operation.

The window shade arrangement according to the invention is suitable for all windows in a motor vehicle i.e., for rear windows, for side windows, as well as for roof skylights. Common to all these shade arrangements is that they have a winding shaft to which the roller blind shade is fastened with an edge. The edge of the roller blind away from the winding shaft is provided with a loop disposed about a tension or pull rod. In order to roll or reel in the roller blind onto the winding shaft, a spring drive is connected to the winding shaft and it generates a prestress moment as defined by the rolling of the roller blind.

Depending on the embodiment of the shade, the tension member or pull rod is guided in at least one guide rail. These conditions exist, for example, in the triangular shaped part of a two-part rear side window. In other applications, the pull rod is guided on both ends in two guide rails that run generally parallel to one another.

The pull rod is driven with one or two linear driving elements, which run along the guide rail and generates feeding power in the sense of drawing the roller blind from the winding shaft. In some cases, it is also provided for the driving element not only to push the pull rod outwardly of the winding shaft, but also to return the pull rod toward the winding shaft so a weaker spring drive motor can be used.

In order to avoid danger of injury during power-driven movement of the pull rod, a braking device is provided that has a combined effect with the guide rail. When a retracting power that exceeds a given level is exerted on the pull rod, because for example a body part is caught in the roller blind, the braking device is activated which directs at least a part of the feeding power into the guide rail. As a result, the force that acts on the caught body part is kept below the risk of injury.

The force for activating the braking device is selected such that it is greater than the force needed to pull the roller blind from the winding shaft, wherein the roller blind is dragged, if necessary also through slot edges. The retarding power resulting therefrom must be taken into account and should not result in activating the braking device.

The braking device can be designed such that it is effective only in one direction, for example only when the shade is being extended, or it can also be structured such that it works bidirectionally. This would prevent severe injuries from occurring, for instance, even when the part of the pull rod or tension member extending laterally beyond the roller blind moves downwardly through a guide groove. Here, there is risk of injury when the tension rod is coupled with the driving element in a positive-locking manner in both drive directions.

The braking device is provided with a readjusting device in order to guide the braking device back into the lifted or free-wheeling state when no additional retarding power acts upon the tension rod. The restoring device will, so to speak, act simultaneously as a sensor thereof, and determine whether the braking device will be activated or will remain at rest.

Various embodiments of the braking device are possible. In accordance with one embodiment, the braking element is formed by the guide piece itself, while in another case, the braking element is stored in a movable manner with respect to the guide piece.

In both cases, it is possible to allow the braking device to work only in a frictionally engaged condition, or also in a positive-locking condition. For this purpose, the guide rail can be provided with corresponding teeth, for example in the form of a milled knob with relatively flat, small tooth spaces that lie close to one another or with a pronounced, deep, toothing.

When the braking element is guided on the guiding element, at least parts thereof are pushed against the guide rail when the braking effect occurs. For this purpose, the guide piece has inclined planes that correspondingly move the braking element sideways. The inclined planes may be in the form of a conical surface on a face of the guide piece.

It is also possible for the braking element to be elastomeric. In the braking state, the braking element can be distorted, for example compressed, and lays on the guide rail such that it creates the braking force.

Other objects and advantages of the invention will become apparent upon reading the following detailed description and upon reference to the drawings, which:

### BRIEF DESCRIPTION OF THE DRAWINGS

FIG. 1 is a broken open perspective of a rear area of a motor vehicle having a roller window blind or shade in accordance with the inventions;

FIG. 2 is a schematic depiction of the window shade of the present invention, shown in an extended position;

FIG. 3 is an enlarged fragmentary section of one of the guide members for the illustrated roller blind with a braking element in accordance with the invention shown during movement of the window shade in a guide rail;

FIG. 4 is an enlarged fragmentary section, similar to FIG. 3, showing the braking element of the guide in a braking condition;

FIG. 5 is an enlarged fragmentary section of an alternative embodiment of a guide member and braking element according to the invention;

FIG. 6 is an enlarged fragmentary section, similar to FIG. 5, showing the braking element of the guide in a braking condition;

FIG. 7 is an enlarged fragmentary section of still another alternative embodiment of guide member and braking element according to the invention; and

FIG. 8 is a side elevational view of the guide and braking element shown in FIG. 7 in a braking condition.

While the invention is susceptible of various modifications and alternative constructions, a certain illustrative embodiments thereof have been shown in the drawings and will be described below in detail. It should be understood, however, that there is no intention to limit the invention to the specific forms disclosed, but on the contrary, the intention is to cover all modifications, alternative constructions, and equivalents falling within the spirit and scope of the invention.

### DETAILED DESCRIPTION OF THE INVENTION

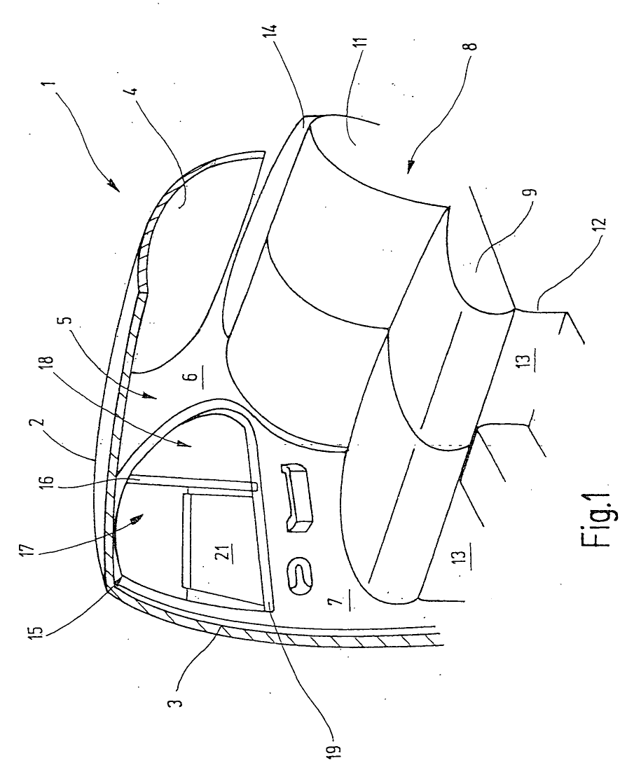

Referring now more particularly to FIG. 1 of the drawings, there is shown an illustrative motor vehicle having a side window roller blind assembly in accordance with the invention. FIG. 1 represents a cut-away rear area of a passenger car. The figure illustrates a view towards the right-side interior, which is the mirror image of the not-shown left-side interior. The view is simplified; for example, car body interior structures such as braces and attachment means are not shown because their illustration is not necessary for understanding the invention.

The illustrated car body section 1 has a roof 2 from which a B-column 3 extends downwardly at the side to a an underbody. A corresponding B-column is provided on the opposite side of the vehicle. The roof 2 transitions at its rear edge into a rear window 4. At the side, the rear window 4 ends at a C-column 5 located at a distance from the B-column 3. The C-column 5 carries an interior lining 6.

Between the B-column and the C-column, a rear right side door 7 is hinged in a known way to the B-column. At the height of the right rear side door 7 there is a rear seat bench 8 which includes a sitting surface 9 and also a rear seat back 11. The rear seat back 9 is supported on a base surface 12 that is part of the underbody in front of which are foot spaces 13. At the height of the top edge of the rear seat back 11, a rear seat shelf 14 extends to the bottom edge of the rear window 4.

The right rear side door 7 is provided with a side window 15 typical for sedans. The side window 15 is divided by a vertical brace 16 into essentially a four-cornered window panel 17 as well as a generally triangular configured window panel 18. The window panels are bordered by an apron or frame 19 having a rounded end that forms an angle less than 90°. The window panel 17 is moveable upwardly and downwardly in a known manner, being guided in part by the vertical brace 16.

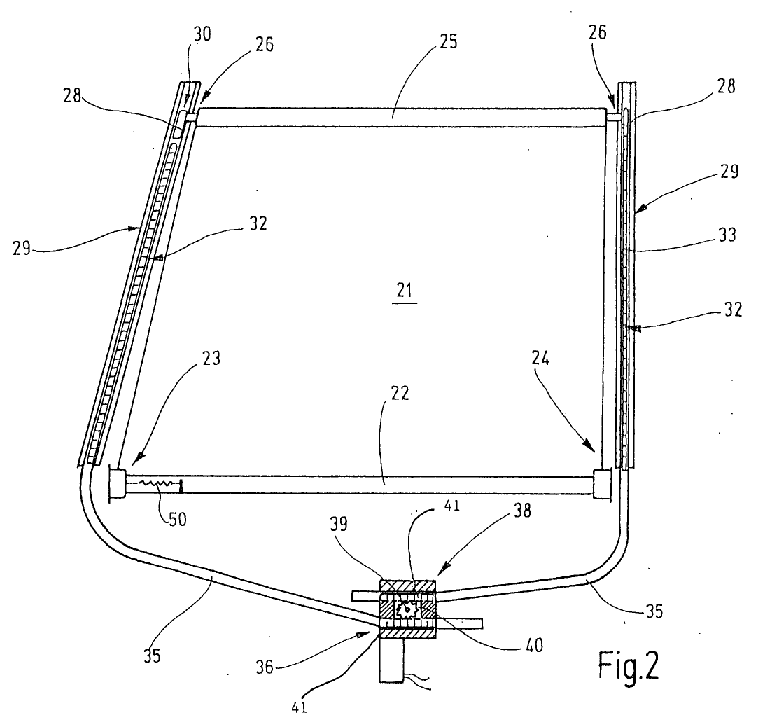

The window panel 17 in this case may be selectively shaded by a roller blind 21, which may be drawn out of the inner space of the door 7 through a groove in the apron 17. A drive mechanism for the roller blind 21, as depicted in FIG. 2 is disposed in the interior of the door below the apron 19.

The illustrated roller blind 21 has a section, which generally corresponds to the surface of the window panel 17 and has essentially straight edges. The roller blind 21 is fastened with its lower edge on a winding shaft 22, which is rotatably supported between winding shaft support arrangements 23, 24.

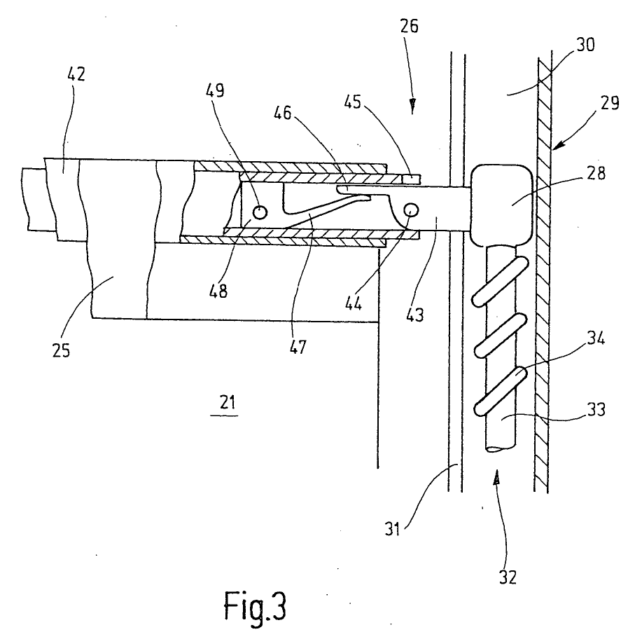

The edge of the roller blind 21 away from the winding shaft 22 forms a tubular loop 25, through which a pull rod or tension member passes, with only outer extending overhang-arms 26 thereof being seen in the drawings. The construction of the overhang-arms 26 and the tension member arrangement is depicted in FIG. 3 as described in greater detail below. Such overhang-arm 26 has a guide 28 on the end side.

In order to guide the roller blind 21 during an extension movement, two guide rails 29 run laterally beside the drawn out roller blind 21. Each guide rail 29 has a slot chamber 30 running in the longitudinal direction, which is generally circular in cross sections and opens toward the roller blind 21 via a notch slot 31.

In both slot chambers 30 of the two guide rails 29 run axially movable thrust elements 32. Each thrust element 32 consists of a cylindrical core 33, around which a raised helix 34 is provided. The helix 34 forms a tooth running helically around the core 33. The thrust element 32 consequently has the shape of a flexible toothed rack with circular cross section. The thrust elements 32 themselves are not buckle-resistant, and hence, are guided in the slot chamber 30 in such a way as to avoid bending.

At the lower end of each guide rail 29, guide tubes 35 connect the guide rails 29 to a drive motor 36. The drive motor may be a dc motor having a gear box 38. An output shaft 39 has a gear wheel 40 designed to the drive thrust elements 32 in a known manner as the thrust elements tangently pass the rear wheel 40 and are retained in buckle-resistant fashion. In order to prevent the thrust elements 32 from tilting from side to side, they are guided in boreholes 41 that run tangentially past the output gear 40. The guide tubes 35 fit into these boreholes 41. There also is room in the extension of the boreholes 41 for storing that guide the non-active part of the thrust element in an orderly manner.

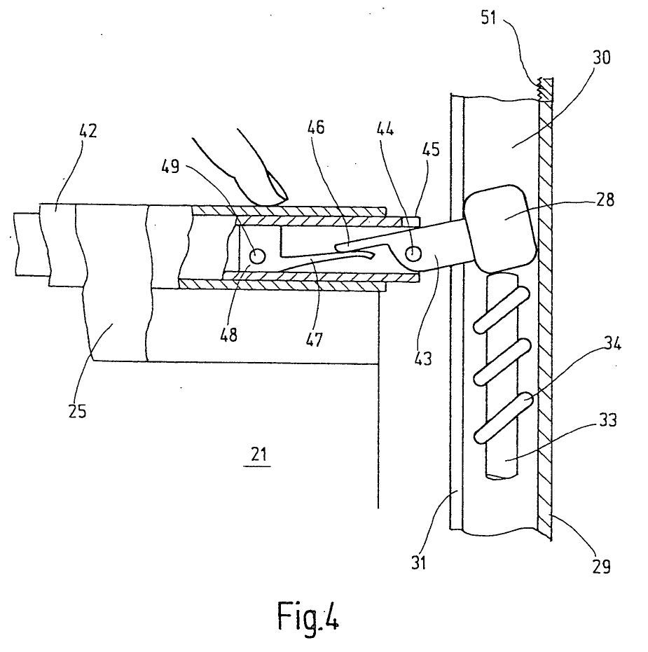

The construction and operation of the overhang arm 26, guide 28 and their combined effect with the guide rails 29 can be understood with reference to FIGS. 3 and 4. FIGS. 3 and 4 show, with reference to FIG. 2, the right end of the illustrated tension member arrangement, together with a section of roller blind 21. It will be understood that the following explanation in connection with FIG. 4 also applies by analogy to the other end of the tension member arrangement and the combined effect there with the guide rail 29 on the left side.

The guide 28, as depicted in FIG. 3, has a shape which in cross section is adapted to the cross section of the slot chamber 30. Seen in the lengthwise direction of the guide rail 29, it has a length only marginally greater than the diameter of slot chamber 30. As a result, the guide may easily run through the slot chamber 30 when its longitudinal axis, i.e., the axis that lies in the moving direction, is oriented parallel to the axis of the slot chamber 30. Such movement in the guide chamber 30 is prevented, however, if the guide 28 becomes slightly slanted in slot chamber 30. A pinching effect occurs, as is commonly known from sliding drawers or compartments. In this manner, guide 28 can function like a braking element to the feeding power of the driving member 32 in the guide rail 29.

As can been seen in FIG. 3, the tension member 42, which is insertably disposed within the loop 25, includes the overhang arm 26 that is telescopically disposed within the tension member 42. Because of telescopic shiftability of the overhang arm 26, the width of the tension member 42 is adaptable to the varying width of the window between the guide rails 29, which increases toward the winding shaft.

The guide 28 is connected to the overhang arm 26 via a connecting arm 43, which extends though the guide groove 31 of the guide rail 29. The connecting arm 43 projects into an inner tube of the tension member 42 and is connected thereto via a hinge bolt 44. The hinge bolt 44 allows the connecting arm 43 to be swiveled with respect to a swiveling axis, which is perpendicular to the plane of FIG. 3. In order for the connecting arm 43, which has a generally rectangular cross section, to swivel sufficiently, the tubular extension of the tension rod 42 is provided with a groove 45 above the hinge axis 44.

In the interior of the tension member 42, the connecting arm 43 has a short extension 46, which in the idle position, as shown, is close to the inside of the tubular tension member formed with the groove 45. In order for the extension 46 to remain in such position adjacent the tubular member 46, a plate spring 47 is provided, which may be a plastic spring member, integrally extending from retaining block 48, which is secured in the tubular member by a rivet 49.

The mode of operation of the foregoing arrangement is as follows:

In the retracted state, the tension member 42 is directly adjacent to the winding shaft 22, i.e., it is withdrawn underneath the side rail 19 of the side window 17. If the user, starting from this position, wants to move the roller blind 21 in front of the window 17, he starts the drive motor 36. As a result, the two thrust elements 32 are synchronously fed into the appropriate guide rails 29. In the process, they push the guides 28 upwardly on both sides of the roller blind 21. A spring drive 50 acts against this feed motion, as schematically indicated in FIG. 2. The force of the spring drive 50 constantly strives to roll up the roller blind, i.e., to draw back or hold, the roller blind 21 on the winding shaft 22.

The force of the leaf spring 47 exerts on the extension 46 of the connecting arm 43 such a holding torque that the guide 28 stays in a position in which it can easily slide through the slot chamber 30, although the thrust element 32 on the guide 28 generate a torque that wants to turn the connecting arm counterclockwise.

If on the other hand, as shown in FIG. 4, in addition to the force that the spring drive 50 generates, a further force acts upon the edge of the roller blind 21 lying in front in the moving direction, i.e., presses against the tube 42, the thrust element 32 on the guide 28 opposite the hinge axis 44 generates a torque greater than the self-aligning torque that stems from the spring 47. As a result, the guide 28 will be forced diagonally in the slot chamber 30. Depending on the dimensioning of the guide 28, at least a part of the feeding power of the driving element 32 is directed into the guide rail 29 via the now tilted guide 28, thereby minimizing the force of the moving rod 25 sufficient to prevent bodily injury. Indeed, by appropriate design, the guide 28 can be caused to jam until the propelling power of the guide element 32 is completely directed into the guide rail 29.

As soon as the force that suspends movement of the front edge of the roller blind 21 is eliminated, the plate spring 47 will turn the extension 46, and consequently also the connecting arm 43, back again into the position as shown in FIG. 3 and for enabling the shade to run normally. It will be appreciated in the foregoing braking device in which the braking element is formed by the guide 28, the braking effect takes place through friction contact.

It is also possible to provide the slot chamber 30 on the side opposite the slot groove 31 with a knurling, as a result of which on the side opposite the slot groove 31 a number of small, strip-shaped teeth 51 are formed, as shown in FIG. 4, which are oriented crosswise to the longitudinal direction of the guide rail 29 and whose length roughly corresponds to the width of the slot groove 31. It also is easy to provide to the guide 28 at that position with complementary teeth 51, which lie opposite the toothing 51 of the slot chamber 30. Upon tilting of the guide 28 in the above-described manner, the toothings 51 would interlock into one another so that a positive-locking braking effect, i.e., a blocking, would occur.

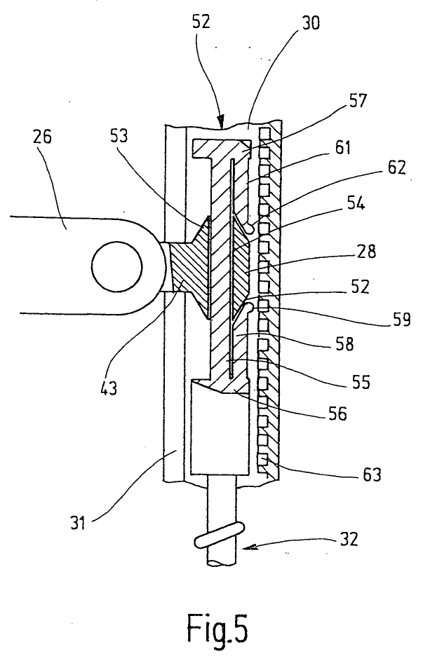

FIG. 5 shows an embodiment with a separate braking element 52, which is movable with respect to the guide 28, wherein parts similar to those described above have been given similar reference numerals. The guide 28 in this case is part of a connecting arm 43. It has a cylindrical shape with truncated cones 52, 53 at opposite ends. The connecting arm 43 in turn is fixedly connected to the overhang arm 26 and the latter is longitudinally movable in the tubular tension member. The guide 28 is aligned such that it easily runs through the guide chamber 30.

Passing through guide 28 is a bolt hole 54 which serves to movably accommodate a rod 55 of the braking element 52. The rod 55 has cylindrical heads 56, 57 on its opposite both ends. Extending from the head 56 toward the guide 28 is a spring arm 58, which has a nose 59 on its free end. On the head 57, there is likewise a spring arm 61 which has a nose 62 on its free end. The back wall of the slot chamber 30 opposite the slot groove 31 is formed with equidistantly spaced small recesses 63 into which the noses 59, 61 can catch.

The function of this braking arrangement is as follows:

With the driving element 32 connected to the head 56 as depicted, a force can be transmitted to braking element 52 either upwardly or downwardly. The force transmitted upwardly in this case corresponds to the extension of the roller blind, while the force operating downwardly is effective when the roller blind 21 is reeled in. The force operating downwardly or in a pulling manner supports the operation of the spring drive 50 and overcomes the sliding friction forces of the guide 28 and of the braking element 52 in the guide rail 29.

Insofar as no additional external force which would have a retarding effect acts upon the front edge of the roller blind 21, the two spring arms 61, 58 take the position shown in FIG. 5. In this position, the noses 59, 62 opposite the outer contour of the heads 56, 57 are withdrawn and cannot engage the adjoining wall of the slot chamber 30. This guide 28 and braking element 52 therefore can easily run through slot chamber 30 in its lengthwise direction. This position between braking element 52 and guide 28 is maintained by the spring arms 58, 61 in conjunction with conical ends 52, 53. The restoring force of spring arms 58, 61 is designed such that a considerable force is necessary in order to move the braking element 52 with respect to the guide 28. For such a relative movement, the spring arms 61 or 58 are radially pushed outward by the inclined planes as a result of truncated cones 52, 53. Accordingly, the propelling power of the driving element 32 is transmitted via the inclined planes of spring arms 58, 61 and of the guide 28.

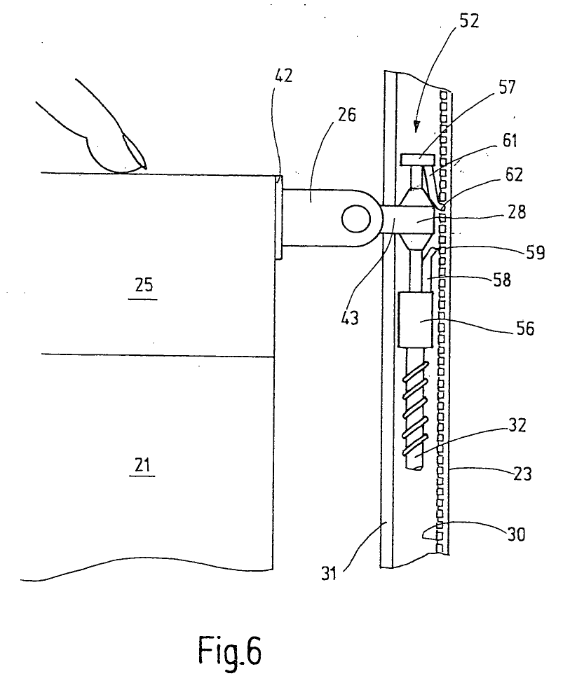

If as shown schematically in FIG. 6, a body part comes into the movement path of the front edge of the roller blind 21 during extension, an additional resistance force arises to that of the restoring force of the spring drive 50. These forces strive to retard the guide 28 with respect to the braking element 52. However, since the driving element 32 continues to be brought forward, the lower spring arm 58 runs increasingly onto the truncated cone 52 and is radially pushed outward. Depending on the force, the spring arm 58 is pushed outwardly until the nose 59 on the free end engages into one of the recesses 63. This blocks further movement and prevents the danger of an injury to the user.

FIG. 6 illustrates the situation when a force does not act upon the front edge to prevent an extension, but rather, when for example during reeling-in, an object catches between the overhang arm 26 and the window wall 19. In order to avoid severe injury in this case, the upper spring arm 61 is pressed outwardly in the manner previously explained as a result of the effect of the truncated cone 53. The nose 62 penetrates into one of the recesses 63 and blocks a further withdrawal of the front edge or of the overhang arm 26 to again prevent serious severe injury.

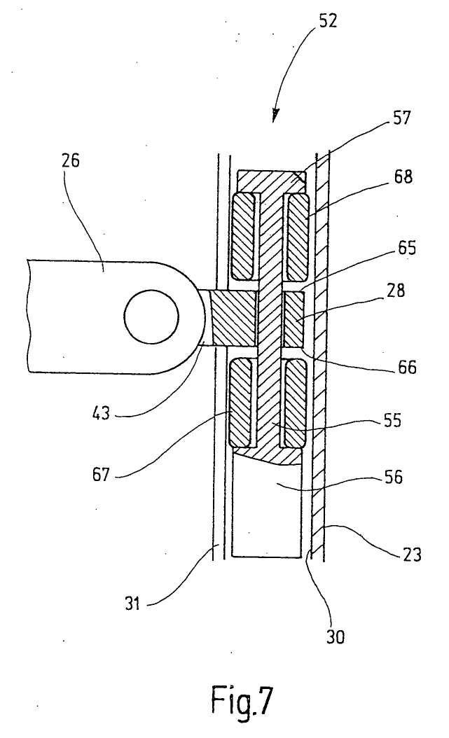

FIG. 7 shows an embodiment of the invention, similar to FIG. 5, in which the braking element 52 is partly an elastomer, wherein items similar to those described above again have been given similar reference numerals. The guide 28 in this case has end faces 65, 66, which face in the respective moving directions. Two tubular elastomer bodies 67, 68 each positioned on the rod 55 of braking element 52 between the guide 28 and heads 56, 57 of the braking element.

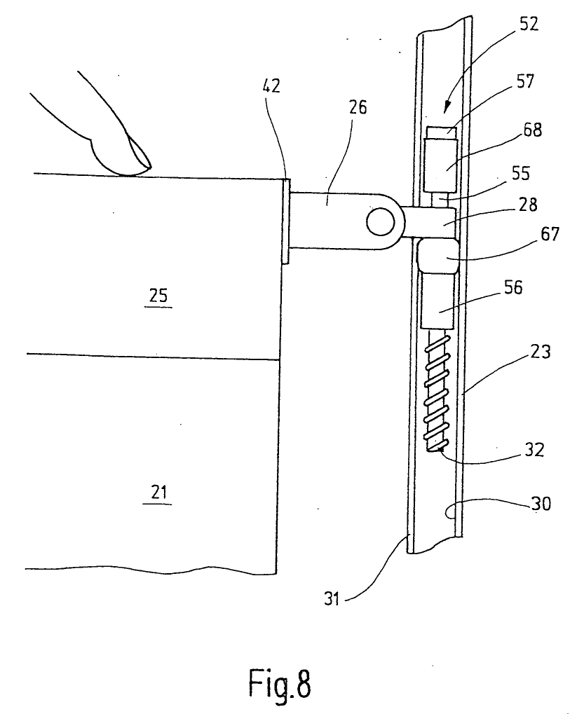

Should an obstruction in movement of the tension rod 25 occur as described above, depending on the moving direction, one of the two elastomer bodies 67, 68 is caught and squashed between the guide 28 and the adjacent head 56 or 57. As a result, of such axial compression, as depicted in FIG. 8, the elastomeric body 67 or 68 will be pressed outwardly against the inner wall of slot chamber 30. As a result, at least a part of the drive force stemming from the driving element 32 will be transmitted to into the guide rail 29 before dangerous injuries can occur. FIG. 8 shows the situation during extension. During reeling-in, a similar situation occurs, the difference being, that elastomer body 68 and not elastomer body 67 is compressed.

The embodiments according to FIGS. 5 and 7 operate bidirectionally, while FIG. 3 shows an arrangement which operates only during an extension of the roller blind. The reeling-in is not protected in the embodiment according to FIG. 3 during reeling-in movement. However, it is not difficult to discern that the embodiments according to FIGS. 5 and 7 could also be designed to operated in one direction, with the upper spring arm 61 being omitted in embodiment according to FIG. 5 and the driving element 32 lying flush on the lower head 56 instead of being connected thereto in a tension-proof and compression-proof manner. In the exemplary embodiment according to FIG. 7, the upper elastomer body 68 could likewise be illuminated if the driving element 32 was merely positioned compression-proof instead of being linked tension-proof and compression-proof with the lower head of the brake element 52.

From the foregoing, it can be seen that in the window shade of the invention there is a braking device for each guide rail, which ensures that at least a part of the propelling power necessary for moving the window shade is directed into the guide rail when the moving front edge of the window shade bumps into an obstacle.

1. A window roller blind assembly for motor vehicles comprising:
a roller blind (21) having an attachment edge at one end,
a wind-up shaft (22) to which the attachment edge of the roller blind (21) is affixed,
a spring drive (50) for exerting a rotary torque on the wind-up shaft (22) in a wind-up direction for winding the roller blind (21) onto the wind-up shaft (46),
a tension rod connected to an end of the roller blind opposite said attachment edge for drawing said roller blind outwardly from said wind-up shaft,
a guide rail (29) adjacent a side of said roller blind (29) for guiding movement of said tension rod,
a linear driving element (32) movable along the guide rail for powering the tension rod and roller blind outwardly from said winding shaft (22), and
a braking device responsive to the driving power of said driving element exceeding a predetermined force for directing at least part of the power to said tension rod into said guide rail for braking continued movement of said tension rod along said guide rail.

2. The window roller blind assembly of claim 1 in which said braking device is operable for braking movement of the tension rod and roller blind only when the tension rod and roller blind are being moved in an unwinding direction away from said wind-up shaft.

3. The window roller blind assembly of claim 1 in which said braking device is operable for braking movement of said tension rod when the force on said tension rod exceeds a predetermined value during either winding or unwinding movement of the roller blind relative to said wind-up shaft.

4. The window roller blind assembly of claim 1 in which said braking device includes an elastomeric member which is deformable in response to force directed to the tension rod exceeding said predetermined level for frictionally engaging said guide rail.

5. The window roller blind assembly of claim 4 in which said elastomeric member is designed to detect the difference between the force to said tension rod for unwinding said roller blind from said wind-up shaft and the force on said tension rod in a direction for winding said roller blind on said wind-up shaft.

6. The window roller blind assembly of claim 1 in which said predetermined force directed to said tension rod for activating said braking device is greater than the force acting upon said tension rod by said spring drive.

7. The window roller blind assembly of claim 1 in which said tension rod has a guide member (28) which cooperates with said guide rail in braking continued movement of said tension rod when the force exerted thereon exceeds said predetermined force.

8. The window roller blind assembly of claim 7 in which said guide member (28) is part of the braking device.

9. The window roller blind assembly of claim 12 in which said tension rod has a guide member that cooperates with said braking device to effect braking of continued movement of the tension rod when the force to the tension rod exceeds said predetermined force.

10. The window roller blind assembly of claim 7 in which said guide member is moveable between a first position in which it can smoothly run in said guide rail and a second position in which it becomes jammed in said guide rail.

11. The window roller blind assembly of claim 10 in which said guide member is pivotable about an axis perpendicular to a plane defined by the roller blind when in an open extended position from said wind-up shaft.

12. The window roller blind assembly of claim 10 in which said guide member is moveable to said second position in frictionally-engaged relation to the guide rail.

13. The window roller blind assembly of claim 10 in which the guide member is moveable to said second position in positively-locking engagement with the guide rail.

14. The window roller blind assembly of claim 10 in which said guide member is positively engageable with said guide rail only when the tension rod is moving in one direction of movement relative to the wind-up shaft.

15. The window roller blind assembly of claim 1 in which said braking device brakes continued movement of the tension rod by frictional engagement with the guide rail.

16. The window roller blind assembly of claim 1 in which the braking device brakes continued movement of the tension rod by positive locking engagement with the guide rail.

17. The window roller blind assembly of claim 7 in which the braking device is moveable with said guide member.

18. The window roller blind assembly of claim 7 in which said braking device includes a braking element that is guided for longitudinal movement on said guide member, said braking element being oriented parallel to the direction of movement during movement with said guide piece in the guide rail.

19. The window roller blind assembly of claim 7 in which said guide member two end surfaces face in directions parallel to the direction of movement of said guide member along said guide rail.

20. The window roller blind assembly of claim 19 in which at least one of said end faces is conically shaped.

21. The window roller blind assembly of claim 20 in which said braking device has a braking element with an extension (58,61) that is cooperable with the conical face of the guide member to effect braking of movement of the tension rod.

22. The window roller blind assembly of claim 1 in which the braking device has a nose (59,62) that is engageable with toothing (62) on the guide rail to effect braking movement of the tension rod.

23. The window roller blind assembly of claim 1 in which the braking device is made of an elastomeric material that is deformable into a condition for braking movement of the tension rod relative to said guide rail.

24. The window roller blind assembly of claim 7 in which said braking device is affixed adjacent one side of the guide member.

25. The window roller blind assembly of claim 23 in which said tension rod has a guide member, and said elastomeric braking element is disposed between the guide member and the linear driving element (32).

26. The window roller blind assembly of claim 1 in which the guide rail defines a guide chamber (30) having a slot opening (31).

27. The window roller blind assembly of claim 26 in which said guide rail chamber has a circular cross section.

28. The window roller blind assembly of claim 7 in which said guide member is connected to said tension rod via a neck part (26).

29. The window roller blind assembly of claim 28 in which said neck part (26) is moveable in a direction parallel to said tension rod.

30. The window roller blind assembly of claim 29 in which said neck part (26) extends through a slot (31) of said guide rail into a chamber defined by the guide rail.

31. A window roller blind assembly for motor vehicles comprising:
a roller blind (21) having an attachment edge at one end,
a wind-up shaft (22) to which the attachment edge of the roller blind (21) is affixed,
a spring drive (50) for exerting a rotary torque on the wind-up shaft (22) in a wind-up direction for winding the roller blind (21) onto the wind-up shaft (46),
a tension rod connected to an end of the roller blind opposite said attachment edge,
said tension rod being moveable between extended and retracted positions for extending and retracting said roller blind,
a guide rail adjacent a side of said roller blind for guiding movement of said tension rod,
at least one drive for exerting a force on said tension rod during movement between said positions,
and a braking device responsive to the force acting on said tension rod during operation of said drive exceeding a predetermined level for braking continued movement of said tension rod.

32. The window roller blind assembly of claim 31 in which said braking device is operable for frictionally engaging said guide rail in response to said force acting on said tension rod exceeding said predetermined level for braking continued movement.

33. The window roller blind assembly of claim 31 in which said braking device is an elastomeric member which is deformable in response to the force directed to said tension rod exceeding a predetermined level for frictionally engaging the guide rail.

34. The window roller blind assembly of claim 31 in which said guide rail has a ribbed configuration, and said braking device is engageable with ribs of the guide rail for braking continued movement in response a force exerted on said tension rod exceeding said predetermined level.
